(19) United States
(12) Patent Application Publication
(10) Pub. No.: US 2005/0055866 A1
(43) Pub. Date: Mar. 17, 2005

(54) Gravity-operated separable link

(76) Inventors: Henry Jay Groen, Washington, DC (US); Linwood Pete Smith, Tenants Harbor, ME (US)

Correspondence Address: SUGHRUE MION, PLLC, 2100 PENNSYLVANIA AVENUE, N.W., SUITE 800, WASHINGTON, DC, 20037, US

(21) Appl. No.: 10/656,160

(22) Filed: Sep. 8, 2003

(51) Int. Cl. A01K 91/00

(52) U.S. Cl. 43/43.12

(57) ABSTRACT

A separable link is disclosed that includes a link body with at least first and second positions, wherein, in the first position, the energy-to-yield is greater than the energy-to-yield of the second position.

### FIELD OF THE INVENTION

This invention relates to submersible lines requiring links that separate upon a predetermined tension and that are capable of being used with submerged devices such as lobster traps, oil and gas machinery, and other underwater equipment.

### BACKGROUND OF THE INVENTION

Underwater vertical ropes are a necessity in such industries as fishing, crabbing, waterway designation and oceanographic fuel exploration. The problems associated with vertical ropes, however, are many. For instance, a tether that stretches from a lobster trap on the sea floor to a buoy on the ocean's surface may get tangled in propellers. Worse yet, vertical ropes drown many mammals each year due to accidental underwater entanglement.

The aforementioned problem is more acutely described when one considers, for example, that in the state of Maine alone there are 7,700 commercial lobster license holders, each with an average of 460 traps (Maine Department of Marine Resources, 2002, www.state.me.us/dmr). Based on these figures, and not considering line use for other types of commercial and non-commercial fishing or line use in other industries, the number of underwater vertical ropes approaches 3 million in Maine's territorial waters alone.

Indeed, in much of the ocean shelf areas of the United States and around the world, large marine mammals find themselves navigating an unforgiving, man-made forest of vertical ropes. This forest is an indiscriminate death trap for many large species of mammals, killing many whales each year, some of which are endangered species.

The problem does not end with vertical ropes, however. There is also the problem of floating ropes or “float rope” (the float rope being commonly called “ground line”). Ground lines are used to string together a plurality of lobster traps, for example, floating in seemingly innocuous arcs from lobster trap to lobster trap. As cetaceans swim near the ocean bottom, the ground lines are sometimes caught in their mouths, or on their fins or flukes, causing the same misfortune as previously discussed.

Schemes that attempt to address the above-described problems are disclosed in U.S. Pat. Nos. 5,913,670 and 5,461,821, for example, both of which provide a mechanism for calculated material failure given a predetermined overload on an underwater line. A significant problem with these attempted solutions, however, is that the links provide but one preset tension at which the material fails.

That is, the conventional systems rupture, tear or break at one singular threshold and are therefore unadaptive and non-responsive. The conventional systems cannot differentiate between the situation where the commercial fisherman would like for the link to break away (such as in the case of an entangled mammal) and the situation where the commercial fisherman would like for the link to maintain its structural integrity (such as in the case of retrieving a heavy haul or the instance of a lobster trap becoming lodged on submerged debris). Additionally, the conventional systems can only be used once. That is, in the instance of a calculated material failure, it is impossible to reuse the ruptured, torn or broken material.

### SUMMARY OF THE INVENTION

Accordingly, it is a general object of the present invention to provide a gravity-operated separable link that overcomes all of the disadvantages described above and other disadvantages of the prior art.

It is also an object of the present invention to provide a gravity-operated separable link with a link body and a plurality of connection ends, including at least a first connection end and a second connection end; a strength determination element disposed within the link body and located between the first and second connection ends; in which the strength determination element is gravity-operated and moves between at least first and second positions of the link body; and further wherein when the strength determination element is in the first position, the link body possesses an energy-to-yield that is greater than the energy-to-yield of the link body when the strength determination element is in the second position.

It is a further object of the instant invention to provide a link with an energy-to-yield in a first position that is equal to or less than one or more lines attached to a connection end.

It is a further object of the instant invention to provide a link with an energy-to-yield in a first position that is equal to or more than one or more lines attached to a connection end.

It is an additional object of the present invention to provide a link with a strength determination element that is capable of buoyancy in a submerged situation such that a natural state of the link engages a second position, causing the link body to possess an energy-to-yield which is less than the energy-to-yield of the link body in a first position.

It is yet a further object of the present invention to provide a link with a buoyancy in the strength determination element such that, as the link travels between a submerged situation and a non-submerged situation, a first position is engaged which causes the link body to possess an energy-to-yield that is greater than the energy-to-yield of the link body when the strength determination element is in a second position.

It is a further object of the present invention to provide a link including a plurality of connection ends in which at least one connection end is a swivel connection.

It is an additional object of the present invention to provide a link with a link body that includes a bendable portion in which a second position engages the bendable portion of the link body whose energy-to-yield threshold yields by bending and which energy-to-yield is less than the link body in a first position.

It is yet another object of the present invention to provide a link with a link body that includes a bendable-breakable portion in which a second position engages the bendable-breakable portion of the link body whose energy-to-yield threshold yields by initially bending and then by breaking and which energy-to-yield is less than the link body in a first position.

It is a further object of the present invention to provide a link with a link body including a strength determination element, the strength determination element comprising a female member, a male member, and moveable space fillers; the moveable space fillers being capable of moving to at least a first location and a second location, wherein the first location facilitates a first position providing the link body with an energy-to-yield which is greater than the energy-to-yield of the link body in a second position designated by the moveable space fillers located in a second location.

It is additionally another object of the present invention to provide a link with an airtight chamber.

It is yet another object of the present invention to provide a link with moveable space fillers, which are round, bearing-like members.

It is a further object of the present invention to provide a link with a strength determination element that includes at least one of a bearing-like member, a tube, a plate, and a bar.

### BRIEF DESCRIPTION OF THE DRAWINGS

The invention, both as to its organization and manner of operation, may be further understood by reference to the drawings that include FIGS. 1-4, 5A-B and 6A-B, taken in connection with the following descriptions.

FIG. 1 is an illustration of a non-limiting embodiment of the invention comprising a bendable and/or bendable-breakable portion.

FIG. 2 is an example of a gravity-operated separable link in accordance with an embodiment of the invention.

FIG. 3 is an example of multiple gravity-operated separable links in accordance with an embodiment of the invention used in conjunction with a ground line and multiple lobster traps, wherein the ground line floats in arcs from lobster trap to lobster trap.

FIG. 4 is an action diagram of a gravity-operated separable link in accordance with an embodiment of the invention in which multiple lobster traps are being raised or lowered from a fishing vessel via a trawl line.

FIG. 5A is a diagrammatic view of a conventional system wherein a lobster trap has become lodged on submerged debris.

FIG. 5B is a continuation of the diagrammatic depiction of FIG. 5A, wherein the breakaway element has broken away, leaving the lobster trap at the bottom of the ocean.

FIG. 6A is a view of a gravity-operated separable link in accordance with an embodiment of the invention wherein a lobster trap has become lodged on submerged debris.

FIG. 6B is a view of the gravity-operated separable link depicted in FIG. 6A, wherein the link has engaged a first position with an energy-to-yield that is substantially equal to the energy-to-yield of the line, thus retrieving the lobster trap.

### DETAILED DESCRIPTION OF PREFERRED EMBODIMENTS OF THE INVENTION

The following description of illustrative non-limiting embodiments of the invention discloses specific configurations and components. However, the embodiments are merely examples of the present invention, and the specific features described below are merely used to describe such embodiments and to provide an overall understanding of the present invention. Accordingly, one skilled in the art will readily recognize that the present invention is not limited to the specific embodiments described below. Furthermore, the descriptions of various configurations and components of the present invention that are known to one skilled in the art are omitted for the sake of clarity and brevity.

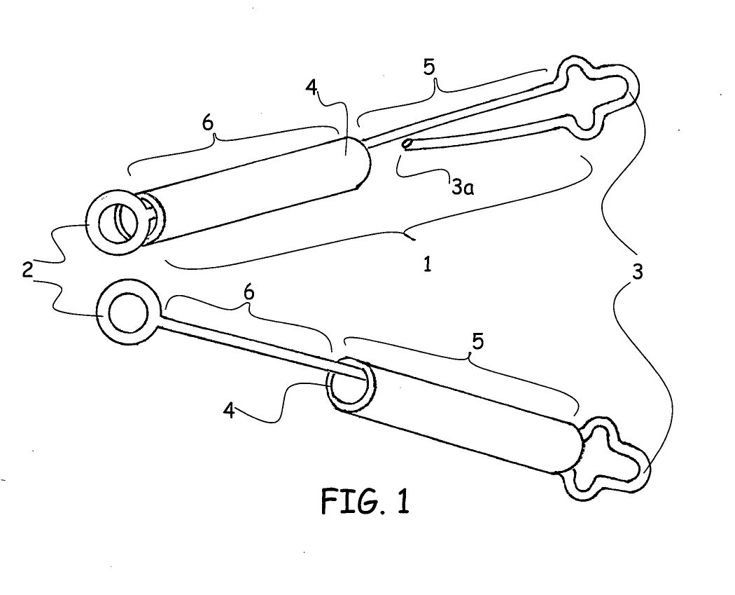

FIG. 1 is an illustration of a non-limiting embodiment of the invention comprising a bendable and/or bendable-breakable portion. As shown in the figure, the gravity-operated separable link comprises a link body 1 with connection ends 2, 3 and strength determination element 4. Any or all of the link body 1, connection ends 2, 3 and strength determination element 4 may comprise metal, wire, polymer, plastic, rubber or other structural material.

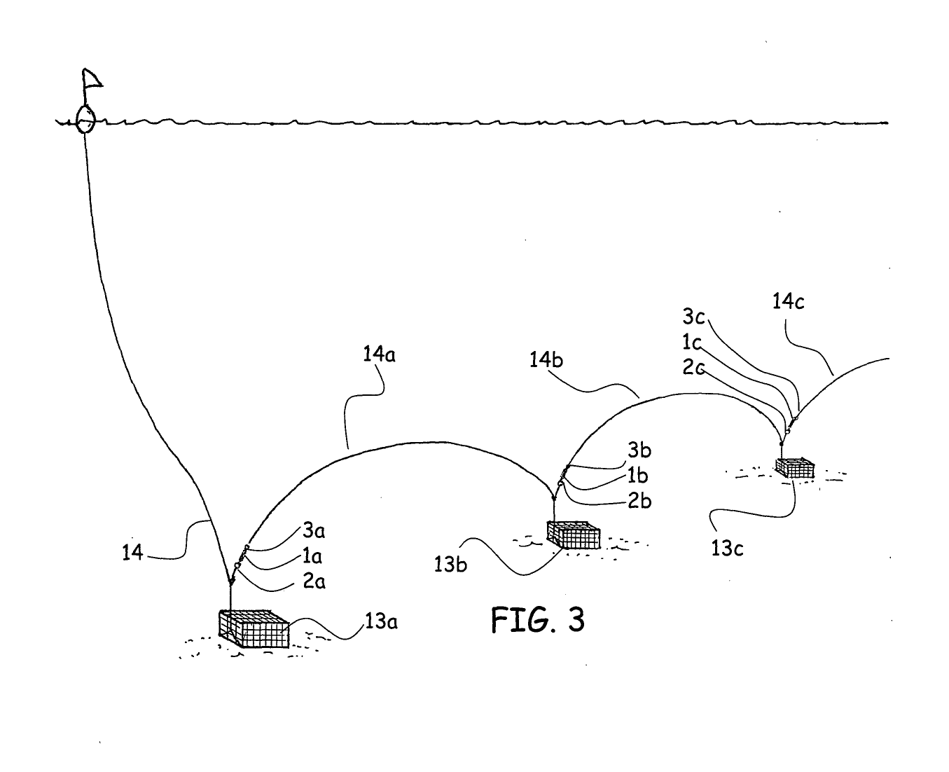

Both or either of the connection ends 2, 3 may be swiveled so as to allow the device to turn on it axis. While first connection end 2 and second connection end 3 are each connected to a ground line (“ground line” being used interchangeably herein to describe “float rope,” buoyant rope, or trawl line), the first connection end 2 is connected closer to a lobster trap (or other underwater device providing anchorage weight) than connection end 3 (for reasons explained below and also as explained in relation to FIG. 3).

Strength determination element 4 is operable to move to either of a first position 5 or a second position 6 on link body 1, depending upon the manner in which strength determination element 4 is generally oriented on link body 1 by attachment to ground lines 14a-c (see FIG. 3) in relation to the direction of gravity. That is, the ground line 14a-c possesses a relative density providing buoyancy, this buoyancy being restrained by the anchorage weight of a lobster trap or other underwater device. Accordingly, the “float rope” ground line 14a-c floats in a substantially arc-like manner from lobster trap to lobster trap.

Based on the arc of the ground line 14a-c, connection end 2 is oriented towards the lower end of the arc (closer to a lobster trap) while connection end 3 is oriented towards the highest vertical point in the arc. Accordingly, in a submerged situation with the lobster traps having been placed on the ocean floor, the float rope ground line 14a-c provides the gravity-operated separable link 1 with a particular orientation in which connection end 3 is tilted higher than connection end 2.

In an additional embodiment, either or both of link body 1 and strength determination element 4 possess a relative density or specific gravity providing buoyancy in water so as to achieve the above-noted orientation.

Accordingly, the instant invention takes on a particular underwater orientation, that is, the gravity-operated separable link body 1 generally “stands” on end, with connection end 3 floating in a direction closer to the surface of the water than does connection end 2 once the anchorage weight has landed on the ocean bottom. In this occurrence, strength determination element 4 moves to a second position 6.

In contrast, when the ground line 14a-c that is connected to connection end 2 is being retrieved (or, conversely, when the apparatus is being sunk to the ocean floor), the lobster trap or other device at the end of the ground line 14a-c holds the ground line 14a-c in a different relative position than that described above, changing the orientation of the gravity-operated separable link 1 such that strength determination element 4 moves to a first position 5.

Hence, because connection end 2 is connected to the ground line 14, 14a-c, the gravity-operated separable link 1 changes its general orientation. That is, the orientation of the link changes from connection end 3 being closer to the surface of the water to connection end 2 being closer to the surface of the water.

Under these circumstances, strength determination element 4 takes on the first position 5. In the first position 5, the link body 1 possesses an energy-to-yield that is greater than the link body in the second position 6, as explained below.

In the first position 5, the tip 3a of connection end 3 is restrained to the confines of strength determination element 4. That is, the tip 3a cannot extend beyond the structural wall of strength determination element 4. Accordingly, tension and orientation provided by the ground line being attached to an anchorage weight (for example, a lobster trap) while the anchorage weight is being raised or lowered will cause the orientation of the link 1 to change such that strength determination element 4 moves to the first position 5, restraining the tip 3a and thus ensuring that connection end 3 with neither bend nor break, short of an energy-to-yield at least substantially equal to the energy-to-yield of the ground line 14a-c.

Along these lines, in a non-limiting embodiment of the present invention, the link body 1 in the first position 5 possesses an energy-to-yield that is equal to or less than any number of lines attached to the link body 1. In an additional non-limiting embodiment of the instant invention, the link in the first position 5 possesses an energy-to-yield that is equal to or more than any number of lines attached to the link. Conventionally, this will be one line. As it has been found that ropes used in underwater applications generally have a tensile strength of between 4,000 and 10,000 lbs. (and usually between 4,000 and 6,000 lbs.), various embodiments of the invention take these values into account in accordance with the above.

In all embodiments of the invention, however, the link body 1 possesses an energy-to-yield when the strength determination element 4 is in the second position 6 that is less than the energy-to-yield of the link body 1 when the strength determination element 4 is in the first position 5.

When the strength determination element 4 is in the second position 6, connection end tip 3a possesses the ability to extend in a direction away from the axis of the link 1, beyond the structural wall of the strength determination element 4. In one embodiment of the invention, when there is a predetermined tension upon the ground line connected to connection end 3, connection end 3 bends as tip 3a moves in a direction away from the axis of the link body 1 due to the application of a predetermined tension. In another embodiment, connection end 3 initially bends and then breaks as tip 3a moves in a direction away from the axis of the link body 1 upon application of a predetermined tension.

To explain the above in greater detail, consider the hypothetical situation of a cetacean swimming and catching a float rope ground line in its mouth when the strength determination element 4 is in the second position 6 due to link body 1 being capable of buoyancy providing a particular orientation. In this instance, the tip 3a moves in a direction away from the axis of the link body 1 and connection end 3 loses the connection to the ground line 14a-c (either by bending or by initially bending and then by breaking). The instant invention is thus enabled to save the whale from drowning.

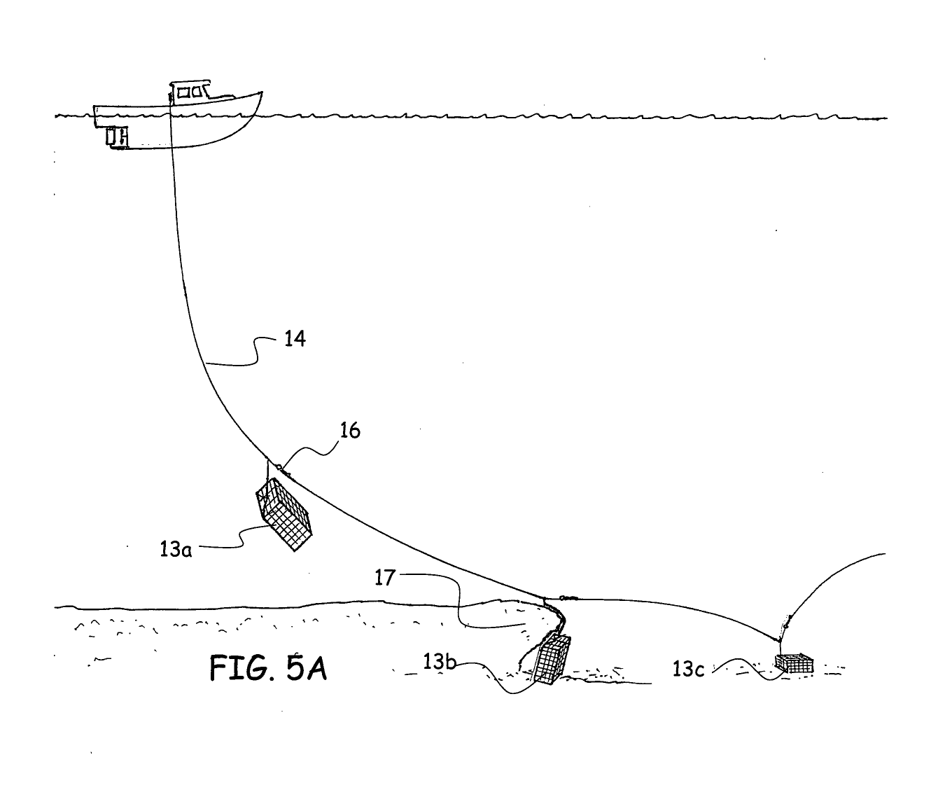

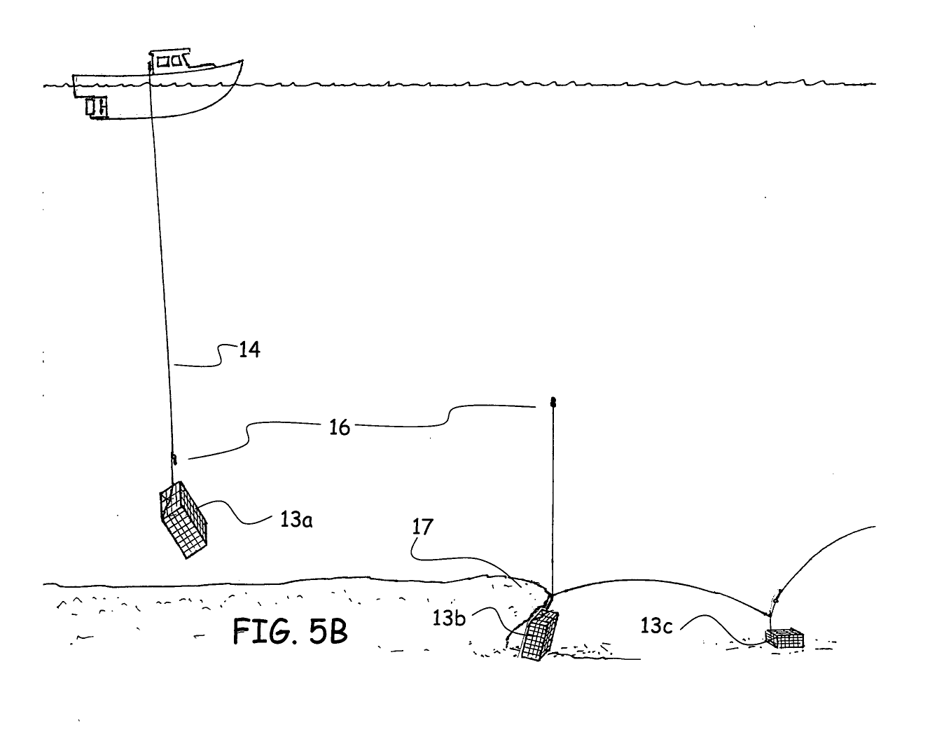

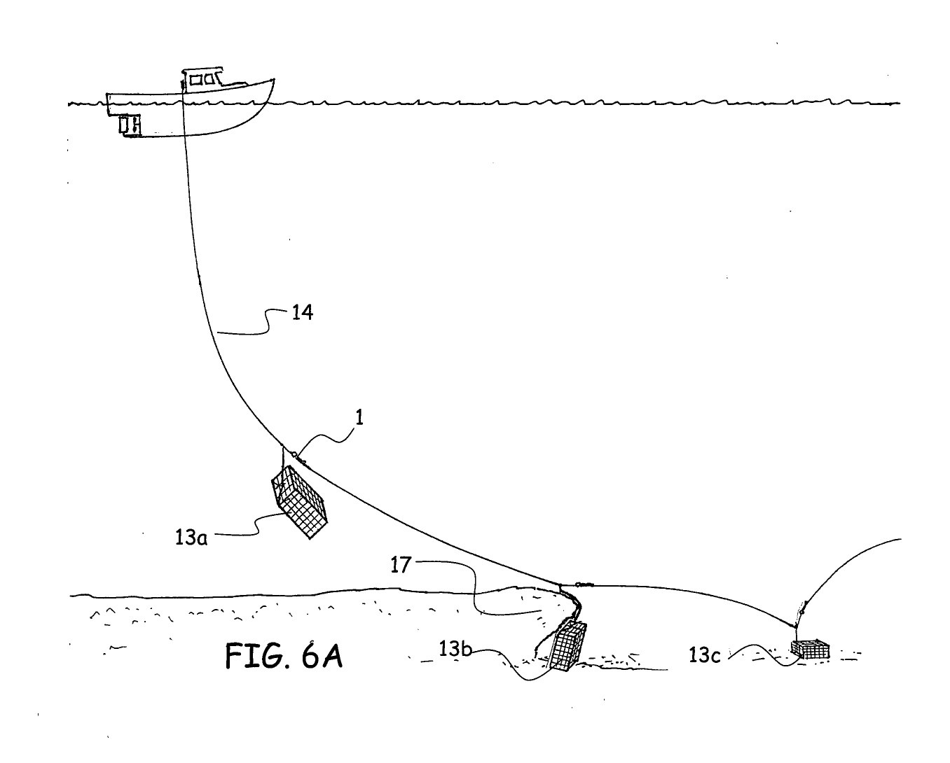

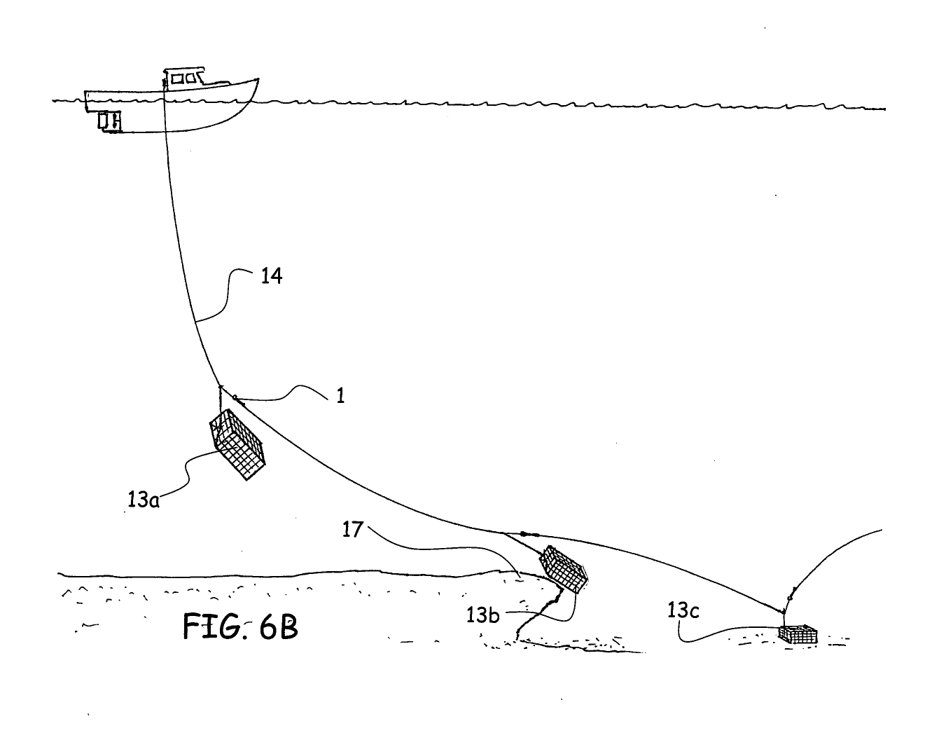

Conversely, the instant invention is adaptable to the differing circumstance of a lobster trap becoming lodged, for example, on underwater debris, or where the underwater anchorage is otherwise faced with circumstances where the fisherman does not desire the link body 1 to possess an energy-to-yield that is less than the lines attached to the link body 1. Such circumstance is graphically portrayed in FIGS. 6A-6B, as later explained and as contrasted against a conventional system as depicted in FIGS. 5A-5B.

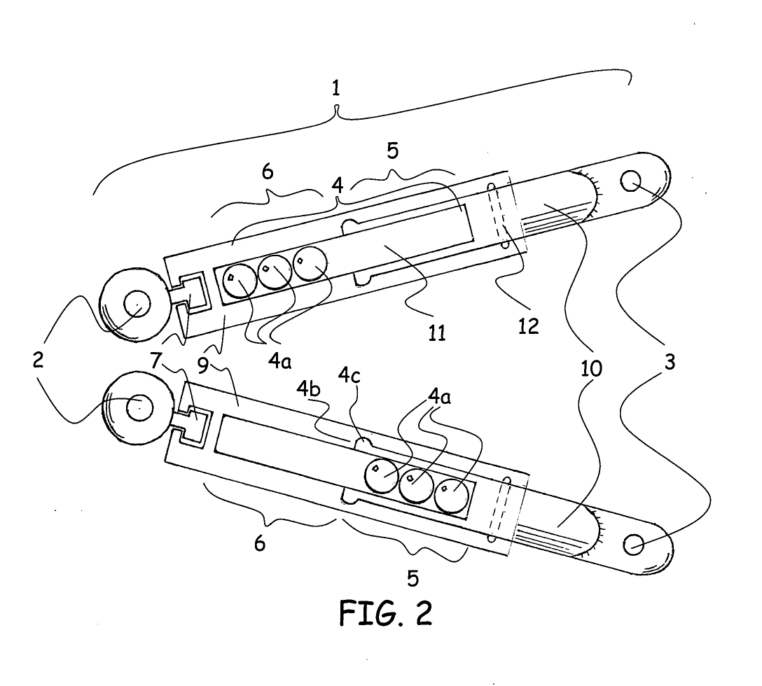

FIG. 2 illustrates a further embodiment of the invention. The gravity-operated separable link includes a link body 1 including first and second connection ends 2, 3, and a strength determination element 4, a female member 9, a male member 10, an airtight chamber 11 and an o-ring 12. Any or all of the link body 1, connection ends 2, 3, strength determination element 4, female member 9, male member 10, airtight chamber 11 and o-ring 12 may comprise metal, wire, polymer, plastic, rubber or other structural material.

One of ordinary skill in the art will readily recognize that strength determination element 4, while depicted as three round, bearing like members 4a, in conjunction with notch(es) 4b and nub(s) 4c, may also comprise a bar, a plate, a tube, or other material capable of filling a space and moving from a first position 5 to a second position 6.

The female member 9 provides, in conjunction with male member 10, an airtight chamber 11. A connection to a ground line 14a-c is made at connection end 2 of female member 9. Such connection is shown in the figure as including a swiveled end element 7. In various embodiments, one or both of connection ends 2, 3 may be swiveled.

One of ordinary skill in the art would readily recognize that while a specific orientation is shown as between connection ends 2, 3 and the female and male members 9, 10, connection ends 2, 3 could readily be swapped/interchanged to either of the male or female members 9, 10. As previously noted, in one non-limiting embodiment, female member 9 provides the cavity in which strength determination element 4 is enabled to move between at least a first and a second position 5 and 6, respectively.

The male member 10 couples to the female member 9 with male member 10 entering female member 9 at an opening end denoted by the o-ring 12. The o-ring 12, when the male member 10 is inserted within female member 9, creates a water- and air-tight seal, enabling the operative qualities of airtight chamber 11. It is readily apparent to one skilled in the art that o-ring 12 could be any number of structural members enabling a watertight quality, including, for example, a chucking flange or additional forms of compression fittings.

When male member 10 is inserted against o-ring 12 and into female member 9, the nubs 4c at the end of male member 10 click and lock into place within notches 4b. The nubs 4c and notches 4b supply a locking mechanism that, by itself, provides a predetermined amount of locking tension that reflects the desired separation ability of the gravity-operated separable link body 1 in the second position 6 at a predetermined energy-to-yield. That is, the nubs 4c and notches 4b provide the ability of the link body 1 to separate in predetermined fashion, such as in the case of a ground line connected at connection end 3 being caught on a cetacean.

Nubs 4c and notches 4b are not restricted to the configuration shown. Various embodiments include elements 4c and 4b comprising various male and female members, including compression fittings, tapered male and female members, convex/concave male and female members, grooved and protruded male and female members, or structural material engineered to undergo a predetermined material failure at a given tension.

As shown in FIG. 2, the link body 1, when strength determination element 4 is in the first position 5, possesses an energy-to-yield which is greater than the energy-to-yield of the link body 1 when the strength determination element 4 is in the second position 6 because when strength determination element 4 is located at the first position 5 within the airtight chamber 11 (the airtight chamber 11 created by female member 9, male member 10 and o-ring 12), the nubs 4c do not possess the ability to leave the notches 4b due to the strength determination element(s) 4a filling the space needed for the nubs 4c to leave the notches 4b.

FIG. 3 is an example of multiple gravity-operated separable links 1a-c in accordance with an embodiment of the invention used in conjunction with trawl line 14, ground line 14a-c and multiple lobster traps 13a-c. Note that trawl line 14 becomes ground line 14a-c. The figure depicts ground line 14a-c buoyantly holding the connection ends 3a-c of multiple link bodies 1a-c in a particular orientation wherein the connection ends 3a-c are generally closer to the surface of the water than any other portion of link bodies 1a-c. The trawl line 14 runs from the surface, being attached either to a buoy or to a boat, becoming at its other end ground line 14a-c attached to a first submerged lobster trap, wherein the ground line 14a-c is then attached to the lobster trap via a short line commonly known as a “gangin” line. The ground line 14a-c then runs from the first lobster trap to second and subsequent lobster traps, connecting to each lobster trap via a short gangin line.

As an aside, while it is commonly known in the art for conventional break-away devices to be located at the buoy (for example, the buoy depicted in FIG. 3), such devices can also be attached to any section of submerged line.

FIG. 3 is meant to depict the general orientation of an embodiment of the instant invention while the embodiment buoyantly floats underwater and is anchored to an anchorage weight such as a lobster trap, thereby engaging the second position 6, as previously discussed. While the figure depicts the ground lines 14a-c as buoyantly upholding the connection ends 3a-c of link bodies 1a-c, it is readily apparent to one skilled in the art that the buoyancy of connection ends 3a-c may be provided by buoyant material within or on link bodies 1a-c, including buoyancy being provided in male member 10, female member 9 (as shown in FIG. 2) or by the strength determination element 4 as shown in FIG. 1. That is, the buoyancy is provided in any number of fashions, so long as the orientation required for the strength determination element 4 to move between a first position 5 and second position 6 as in the circumstances described above is accomplished.

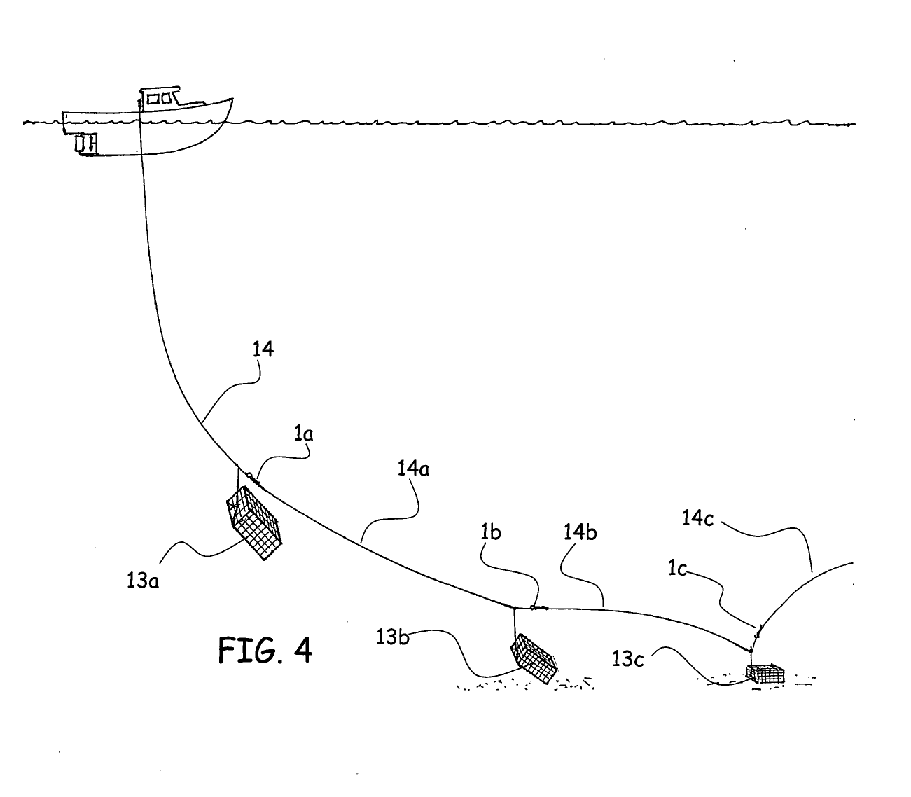

FIG. 4 is an action diagram of a gravity-operated separable link in accordance with an embodiment of the invention in which a lobster trap is being raised or lowered from a fishing vessel. As shown in the figure, lobster traps 13a-c possess a relative density that is heavier than water. When the traps 13a-c are placed overboard or during retrieval from the ocean bottom, the traps 13a-c provide tension against the ground line 14a-c.

That is, when anchorage weight (such as a lobster trap) is being sunk or retrieved to/from the ocean bottom, strength determination element 4 moves to the first position 5, providing the gravity-operated separable link body 1 with an energy-to-yield that is substantially greater than the energy-to-yield of the link body 1 when the strength determination element 4 is in the second position 6. This structure allows lobster traps to be sunk/raised without fear that the separable link is substantially weaker than the lines raising or lowering the lobster trap.

It should be noted that a further non-limiting embodiment of the invention requires that the last end of the trawl line 14 to be placed in the ocean be the first end of the trawl line 14 retrieved. That is, the orientation of the connection ends 2, 3 determines a particular orientation of the link body 1. Because the orientation of the link body 1 determines the placement of the strength determination element 4 (and thus the functionality of a non-limiting example of the device), the last end of the trawl line 14 should be retrieved first in the embodiments described herein. However, it is readily apparent to one of ordinary skill in the art that the order or precise steps of insertion and extraction of the trawl line 14 is limited only by the structure of the device as stated in the claims and is not limited to the insertion/extraction of the ground line 14 in any particular order.

FIG. 5A is a diagrammatic view of a conventional system wherein a lobster trap 13b has become lodged on submerged obstruction 17. As shown in the figure, trawl line 14 is connected to device 16 possessing an energy to yield that is less than the ground line 14.

FIG. 5B is a continuation of the depiction of the conventional system shown in FIG. 5A, wherein the conventional device 16 has broken away, breaking the connection to trawl line 14 and leaving lobster traps 13b-c at the bottom of the ocean. This result is attained because the conventional device 16 is unadaptive and nonresponsive.

FIG. 6A is a view of a gravity-operated separable link 1 in accordance with an embodiment of the invention wherein a lobster trap 13b, being connected to ground line 14 via link body 1, has become lodged on submerged obstruction 17.

FIG. 6B is a further depiction of the gravity-operated separable link 1 depicted in FIG. 6A, wherein the link 1 has engaged a first position 5 (as depicted in FIG. 2) with an energy-to-yield that is substantially equal to the energy-to-yield of the line 14 retrieving the lobster traps 13a-c. As shown in the figure, because the link 1 is adaptive and responsive to differing circumstances as described above, the lobster traps 13a-c are retrieved.

The above embodiments clearly have various advantages over the prior art. Advantageous characteristics in the embodiments of the present invention include: adaptability to respond to varying situations (for example, the ability to separate when entangled with mammals as compared to operating as a strength member when in retrieval mode); simplicity of design; easily replaceable components; cost-effectiveness in view of the previous; a fail-safe design; limitation of potential impact of vertical ropes and ground lines upon ocean life; and potential preservation of the fishing or other industries in light of environmental pressures.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope defined only by the claims below and equivalents thereof.

1. A gravity-operated separable link, comprising:
a link body having a plurality of connection ends including at least a first connection end and a second connection end; and
a strength determination element disposed within said link body and located between the first and second connection ends, said strength determination element being gravity-operated and capable of movement between at least a first and a second position of said link body, said strength determination element comprising a female member, a male member, and moveable space fillers, the moveable space fillers being capable of moving to at least a first location and a second location, wherein the first location facilitates said first position and the second location facilitates said second position; wherein
when said strength determination element is in the first position, said link body possesses an energy-to-yield that is greater than the energy-to-yield of the link body when the strength determination element is in the second position.

2. The link of claim 1, wherein:
the energy-to-yield of the first position is equal to or less than one or more lines attached to said plurality of connection ends.

3. The link of claim 1, wherein:
said strength determination element is buoyant in a submerged situation such that a natural state of the link engages the second position.

4. The link of claim 3, wherein:
the buoyancy of said strength determination element is such that, as the link travels between a submerged situation and a non-submerged situation, the first position is engaged.

5. The link of claim 1, wherein:
the plurality of connection ends includes at least one swivel connection.

6-8. (Canceled).

9. The link of claim 1, further comprising an airtight chamber.

10. The link of claim 9, wherein the moveable space fillers are round, bearing-like members.

11. The link of claim 1, wherein the strength determination element comprises at least one of a bearing-like member.

12. A gravity-operated separable link, comprising:
a plurality of connection ends included at least a first connection end and a second connection end;
strength determination means for determining the energy-to-yield of the separable link, said strength determination means located between the first connection and second connection ends; wherein
said strength determination means comprises a female member, a male member, and moveable space means for filling a space, and is gravity-operated and moves between at least first and second positions; and wherein
the first position possesses an energy-to-yield that is greater than the energy-to-yield of the second position, and
the moveable space means is capable of moving between said first and said second positions.

13. The link of claim 12, wherein:
the energy-to-yield of the first position is equal to or less than one or more lines attached to said plurality of connection ends.

14. The link of claim 12, wherein:
said strength determination means is buoyant in a submerged situation such that a natural state of the link engages the second position.

15. The link of claim 14, wherein:
the buoyancy of said strength determination means is such that, as the link travels between a submerged situation and a non-submerged situation, the first position is engaged.

16. The link of claim 12, wherein:
the plurality of connection ends includes at least one swivel connection.

17-19. (Cancelled).

20. The link of claim 12, further including an airtight chamber.

21. The link of claim 12, wherein the moveable space means includes at least one of a bearing-like member.

22. The link of claim 1, wherein:
the energy-to-yield of the first position is equal to or more than one or more lines attached to said plurality of connection ends.

23. The link of 12, wherein:
the energy-to-yield of the first position is equal to or more than one or more lines attached to said plurality of connection ends.
